(19) United States
(12) Patent Application Publication
(10) Pub. No.: US 2012/0062794 A1
(43) Pub. Date: Mar. 15, 2012

(54) REAL-TIME KEY FRAME SYNCHRONIZATION

(75) Inventors: Ola Hållmarker, Segeltorp (SE); Kent Karlsson, Berkeley, CA (US); Fritz Barnes, Alameda, CA (US)

(73) Assignee: MobiTV, Inc., Emeryville, CA (US)

(21) Appl. No.: 13/227,364

(22) Filed: Sep. 7, 2011

Related U.S. Application Data
(60) Provisional application No. 61/381,865, filed on Sep. 10, 2010.

(51) Int. Cl. H04N 5/06

(52) U.S. Cl. 348/521; 348/E05.011

(57) ABSTRACT

Mechanisms are provided for performing real-time synchronization of key frames across multiple streams. A streaming server samples frames from variant media streams corresponding to different quality levels of encoding for a piece of media content. The streaming server identifiers key frames in the media streams and points in time to sample for key frames that increase the chances of detecting key frames from the same group of pictures (GOPs). In some examples, the sampling point is substantially in the middle between two GOPs. When a connection request is received from a client device for an alternative stream, a measured delay is used to calculate an improved start time.

### CROSS-REFERENCE TO RELATED APPLICATION

This application claims the benefit of priority under 35 U.S.C. §119(e) to U.S. Provisional Application No. 61/381,865 (MOBIP060P), titled “REAL-TIME KEY FRAME SYNCHRONIZATION,” filed Sep. 10, 2010, the entirety of which is incorporated in its entirety by this reference for all purposes.

### DESCRIPTION OF RELATED ART

The present disclosure relates to real-time synchronization of key frames from multiple streams.

Various devices have the capability of playing media streams received from a streaming server. One example of a media stream is a Moving Picture Experts Group (MPEG) video stream. Media streams such as MPEG video streams often encode media data as a sequence of frames and provide the sequence of frames to a client device. Some frames are key frames that provide substantially all of the data needed to display an image. An MPEG I-frame is one example of a key frame. Other frames are predictive frames that provide information about differences between the predictive frame and a reference key frame.

Predictive frames such as MPEG B-frames and MPEG P-frames are smaller and more bandwidth efficient than key frames. However, predictive frames rely on key frames for information and can not be accurately displayed without information from key frames. A streaming server often has a number of media streams that it receives and maintains in its buffers.

In some examples, a streaming server and/or a live encoder receives multiple streams for the same content. The multiple streams may have different bit rates, different frame rates, or different target resolutions. When a client device connects to a streaming server, the streaming server provides a selected media stream to the client device. The client device can then play the media stream using a decoding mechanism.

However, mechanisms for efficiently providing media streams to client devices are limited. In many instances, media streams are provided in a manner that introduces deleterious effects. Consequently, the techniques of the present invention provide mechanisms for improving the ability of a streaming server to efficiently provide media streams to client devices.

### BRIEF DESCRIPTION OF THE DRAWINGS

The invention may best be understood by reference to the following description taken in conjunction with the accompanying drawings, which illustrate particular embodiments of the present invention.

FIG. 1 illustrates a sequence of video stream frames.

FIG. 2 illustrates another sequence of video stream frames.

FIG. 3 illustrates one example of key frames associated with multiple streams.

FIG. 4 illustrates one example of a network that can use the techniques of the present invention.

FIG. 5 illustrates one example of a streaming server.

FIG. 6 illustrates processing at a streaming server.

FIG. 7 illustrates processing at a client device.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular networks and particular devices. However, it should be noted that the techniques of the present invention can be applied to a variety of different networks and a variety of different devices. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

Mechanisms are provided for performing real-time synchronization of key frames across multiple streams. A streaming server samples frames from variant media streams corresponding to different quality levels of encoding for a piece of media content. The streaming server identifiers key frames in the media streams and points in time to sample for key frames that increase the chances of detecting key frames from the same group of pictures (GOPs). In some examples, the sampling point is substantially in the middle between two GOPs. When a connection request is received from a client device for an alternative stream, a measured delay is used to calculate an improved start time.

### Particular Embodiments

Streaming servers receive media streams such as audio and video streams from associated encoders and content providers and send the media streams to individual devices. In order to conserve network resources, media streams are typically encoded in order to allow efficient transmission.

One mechanism for encoding media streams such as video streams involves the use of key frames and predictive frames. A key frame holds substantially all of the data needed to display a video frame. A predictive frame, however, holds only change information or delta information between itself and a reference key frame. Consequently, predictive frames are typically much smaller than key frames. In general, any frame that can be displayed substantially on its own is referred to herein as a key frame. Any frame that relies on information from a reference key frame is referred to herein as a predictive frame. In many instances, many predictive frames are transmitted for every key frame transmitted. Moving Picture Experts Group (MPEG) provides some examples of encoding systems using key frames and predictive frames. MPEG and its various incarnations use I-frames as key frames and B-frames and P-frames as predictive frames.

A streaming server includes a buffer to hold media streams received from upstream sources. In some examples, a streaming server includes a first in first out (FIFO) buffer per channel of video received. When a client device requests a particular media stream from the streaming server, the streaming server begins to provide the media stream, typically by providing the oldest frame still in the buffer. A client device may request a media stream when a user is a changing a channel, launching an application, or performing some other action that initiates a request for a particular media stream or channel. Due to the relative infrequency of key frames in a video stream, the client device will most likely begin receiving predictive frames. Predictive frames rely on information from a reference key frame in order to provide a clear picture. The client device can then either begin displaying a distorted picture using predictive frame information or can simply drop the predictive frames. In either case, the user experience is poor, because the client device can not display an undistorted picture until a key frame is received. Depending on the encoding scheme, a substantial number of predictive frames may be received before any key frame is received.

In order to support the large variety of mobile devices, video broadcasters typically encode each live feed into multiple variant streams with different bit rates, frame rates and screen resolutions. In advanced distribution systems, client devices can take advantage of access to multiple streams and adaptively switch streams when necessary to adjust to available bandwidth, processing power, etc. However, it is recognized that key frames are not synchronized across the multiple variant streams. Furthermore, the positioning of key frames often drifts over time. Consequently, stream changes can often be very disruptive to a user, as there may be notable shifts in time during the transition from one stream to another stream of a different bit rate, frame rate, etc. It is desirable to make the switch seamless for the user, as it is very disruptive if there is a notable jump in time during stream switching.

Consequently, when a device initially requests a stream switch, a number of deleterious effects may occur. A user may experience a notable delay before the user can see an accurate picture. Alternatively, the user may notice a jump in time as a live encoder attempts to locate the nearest key frame during a stream switch. In other examples, a user may experience both a delay in seeing an accurate picture and a jump in time. The techniques of the present invention recognize that the transmission of unaligned key frames and/or unusable predictive frames upon a connection request is one factor that contributes to the deleterious effects.

According to various embodiments, a live encoder and/or a streaming server is tasked with aligning the output across all variant streams. In particular embodiments, key frames are aligned in time for all variant streams. According to various embodiments, there is need for some kind of processing that can compensate for the bad alignment.

By implementing an algorithm that adaptively calculates time offsets for key frames across multiple variants, the input feeds do not need to be perfectly aligned. As long as the maximum distance between two consecutive key frames is smaller than half the GOP size, the algorithm can find the correct adjustment value. By applying this algorithm to the output of live encoders, stream switches can be made perfectly seamless for the end user. This improves user experience and maximizes the usage of available bandwidth.

In many conventional implementations, streaming servers are designed to provide large amounts of data from a variety of sources to a variety of client devices in as efficient a manner as possible. Consequently, streaming servers often perform little processing on media streams, as processing can significantly slow down operation. However, the techniques and mechanisms recognize that is it beneficial to provide more intelligence in a streaming server by adding some additional processing. By using a smart, key frame sensitive buffer in the streaming server, an initial key frame can be provided to the user when a client device requests a connection. Bandwidth is better utilized, wait time is decreased, and user experience is improved.

According to various embodiments, a streaming server calculates time offsets for key frames of different identifies key frames in media streams maintained in one or more buffers. When a connection request is received from a client device, a key frame is provided to the client device even if the key frame is not the first available frame. That is, a key frame is provided even if one or more predictive frames are available before the key frame. This allows a client device to receive a frame that it can display without distortion. Subsequent predictive frames can then reference the key frame. Connection requests such as channel changes or initial channel requests are handled efficiently. Although there may still be delay in transmission and delay in buffering and decoding at a client device, delay because of the receipt of unusable predictive frames is decreased as a streaming server will initially provide a usable key frame to a client device.

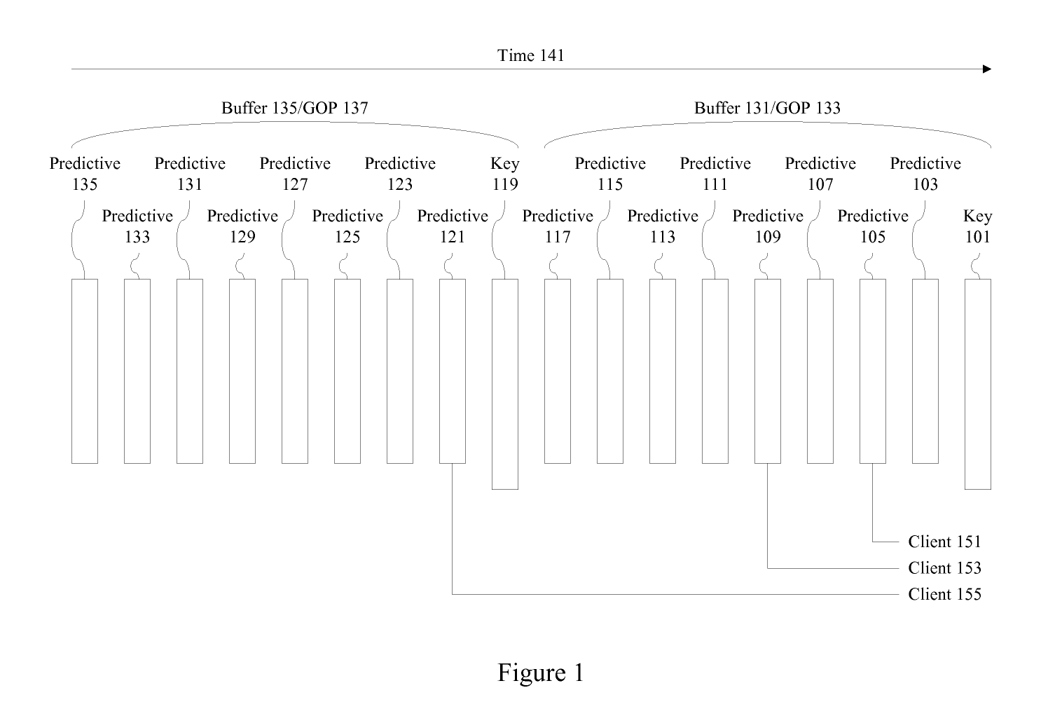

FIG. 1 is a diagrammatic representation showing one example of a sequence of frames. According to various embodiments, a sequence of frames such as a sequence of video frames is received at a streaming server. In some embodiments, the sequence of video frames is associated with a particular channel and a buffer is assigned to each channel. Other sequences of video frames may be held in other buffers assigned to other channels. In other examples, buffers or portions of buffers are maintained for separate video streams and separate channels. In particular embodiments, key frame 101 is received early along time axis 141. One example of a key frame 101 is an I frame that includes substantially all of the data needed for a client device to display a frame of video. Key frame 101 is followed by predictive frames 103, 105, 107, 109, 111, 113, 115, and 117.

According to various embodiments, a sequence of different frames types, beginning with a key frame and ending just before a subsequence key frame, is referred to herein as a Group of Pictures (GOP). Key frame 101 and predictive frames 103, 105, 107, 109, 111, 113, 115, and 117 are associated with GOP 133 and maintained in buffer 131 or buffer portion 131. An encoding application typically determines the length and frame types included in a GOP. According to various embodiments, an encoder provides the sequence of frames to the streaming server. In some examples, a GOP is 15 frames long and includes an initial key frame such as an I frame followed by predictive frames such as B and P frames. A GOP may have a variety of lengths. An efficient length for a GOP is typically determined based upon characteristics of the video stream and bandwidth constrains. For example, a low motion scene can benefit from a longer GOP with more predictive frames. Low motion scenes do not need as many key frames. A high motion scene may benefit from a shorter GOP as more key frames may be needed to provide a good user experience.

According to various embodiments, GOP 133 is followed by GOP 137 maintained in buffer 135 or buffer portion 135. GOP 137 includes key frame 119 followed by predictive frames 121, 123, 125, 127, 129, 131, 133, and 135. In some examples, a buffer used to maintain the sequence of frames is a first in first out (FIFO) buffer. When new frames are received, the oldest frames are removed from the buffer.

When a client 151 connects, the client receives predictive frame 105 initially, followed by predictive frames 107, 109, 111, 113, 115, and 117. Client 151 receives a total of 7 predictive frames that can not be decoded properly. In some instances, the 7 predictive frames are simply dropped by a client. Only after 7 predictive frames are received does client 151 receive a key frame 119. When a client 153 connects, the client receives predictive frame 109 initially, followed by predictive frames 111, 113, 115, and 117. Client 153 receives a total of 5 predictive frames that can not be decoded correctly. In some instances, the 5 predictive frames are simply dropped by a client. Only after 5 predictive frames are received does client 153 receive a key frame 119. When a client 155 connects, the client receives predictive frame 121 initially, followed by predictive frames 123, 125, 127, 129, 131, 133, and 135. Client 155 receives a total of 8 predictive frames that can not be decoded correctly. In some instances, the 8 predictive frames are simply dropped by a client. Only after 8 predictive frames are received does client 155 receive a key frame.

Transmitting predictive frames when a client requests a connection is inefficient and contributes to a poor user experience. Consequently, the techniques of the present invention contemplate providing a synchronized key frame initially to a client when a client requests a new stream.

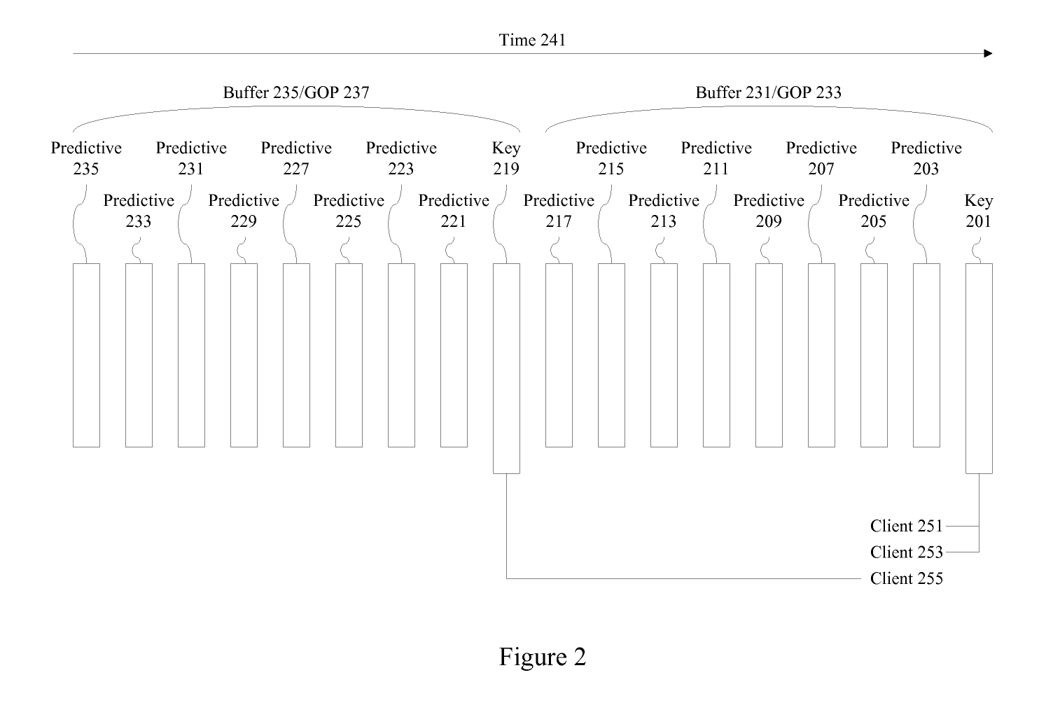

FIG. 2 is a diagrammatic representation showing another example of a sequence of frames. According to various embodiments, a sequence of frames such as a sequence of video frames is received at a streaming server. In some embodiments, the sequence of video frames is associated with a particular channel and a buffer is assigned to each channel. Other sequences of video frames may be held in other buffers assigned to other channels. In other examples, buffers or portions of buffers are maintained for separate video streams and separate channels. In particular embodiments, key frame 201 is received early along time axis 241. One example of a key frame 201 is an I frame that includes substantially all of the data needed for a client device to display a frame of video. Key frame 201 is followed by predictive frames 203, 205, 207, 209, 211, 213, 215, and 217.

According to various embodiments, a sequence of different frames types, beginning with a key frame and ending just before a subsequence key frame, is referred to herein as a Group of Pictures (GOP). Key frame 201 and predictive frames 203, 205, 207, 209, 211, 213, 215, and 217 are associated with GOP 233 and maintained in buffer 231 or buffer portion 231. An encoding application typically determines the length and frame types included in a GOP. According to various embodiments, an encoder provides the sequence of frames to the streaming server. In some examples, a GOP is 15 frames long and includes an initial key frame such as an I frame followed by predictive frames such as B and P frames. A GOP may have a variety of lengths. An efficient length for a GOP is typically determined based upon characteristics of the video stream and bandwidth constrains. For example, a low motion scene can benefit from a longer GOP with more predictive frames. Low motion scenes do not need as many key frames. A high motion scene may benefit from a shorter GOP as more key frames may be needed to provide a good user experience.

According to various embodiments, GOP 233 is followed by GOP 237 maintained in buffer 235 or buffer portion 235. GOP 237 includes key frame 219 followed by predictive frames 221, 223, 225, 227, 229, 231, 233, and 235. In some examples, a buffer used to maintain the sequence of frames is a first in first out (FIFO) buffer. When newer frames are received, a corresponding number of older frames are removed from the buffer.

When a client 251 connects, the client receives no longer receives a predictive frame initially. According to various embodiments, the client 251 receives the earliest key frame available. In some instances, the earliest key frame still available in the buffer may be key frame 201. The client does not need to drop any frames or display distorted images. Instead the client 251 immediately receives a key frame that includes substantially all of the information necessary to begin playing the stream. Similarly, when client 253 requests a connection, the client receives key frame 201 initially. If key frame 201 is no longer available in the buffer, a client connecting would receive key frame 219, even if this means that predictive frames 203, 205, 207, 209, 211, 213, 215, and 217 are skipped. For example, client 255 may connect at a time that would have provided predictive frame 211, but the streaming server intelligently identifies the next available key frame as key frame 219 and provides that key frame 219 to the client 255. No predictive frames are inefficiently transmitted at the beginning of a connection request. According to various embodiments, only key frames are initially provided upon connection requests.

According to various embodiments, a streaming server performs processing on each received frame to determine which frames are key frames. Identifying key frames may involve decoding or partially decoding a frame. In other examples, key frames may be identified based upon the size of the frame, as key frames are typically much larger than predictive frames. In other examples, only a subset of frames are decoded or partially decoded. In still other examples, once a key frame is determined, the streaming server determines the GOP size N and identifies each Nth frame following a key frame as a subsequent key frame. A variety of approaches can be used to determine key frames and predictive frames. Although the techniques of the present invention contemplate efficient mechanisms for identifying key frames, the streaming server does perform some additional processing.

Furthermore, the streaming server may be providing a predictive frame, such as predictive frame 213, to an already connected client while providing a key frame 219 to a new client making a connection request. This can result in a slight but typically unnoticeable time variance in the media viewed by different clients. That is, a first client may be receiving predictive frames 213, 215, and 217 while a second client may be receiving key frame 219 and predictive frames 221 and 223. The techniques of the present invention recognize that this time shift is not disruptive of a typical user experience and a streaming server is typically capable of handling providing different frames from a stream to different client devices.

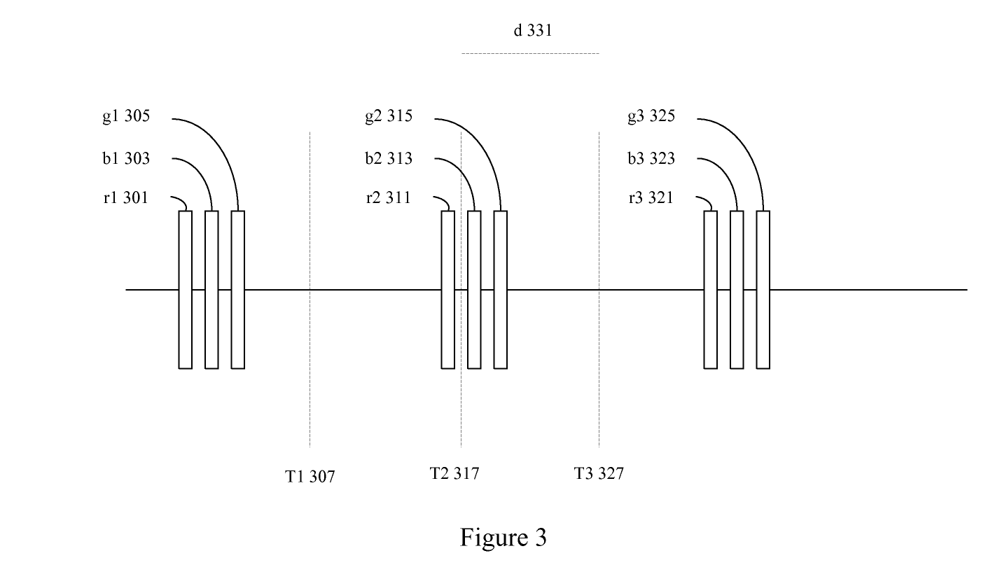

FIG. 3 illustrates one example of key frames associated with multiple streams. Three variants of a stream corresponding to streams r, b, and g are provided. The three variants r, b, and g correspond to three feeds with different qualities (e.g. bit rates). The r, b, and g markers are key frames on a time axis. In particular embodiments, variant r has key frame r1 301, r2 311 and r3 321. Variant b has key frame b1 303, b2 313, and b3 323. Variant g has key frame g1 305, g2 315, and g3 325. According to various embodiments, the key frames are not perfectly synchronized as they do not align in time. The key frames may also drift as encoding for the three streams is not perfectly synchronized.

It should be noted that a number of other frames may reside between key frames. However, only key frames are shown for clarity. In particular embodiments, it is desirable to switch streams by identifying key frames for each variant. If sampling starts at T1, the first key frames detected are r2 311, b2 313, and g2 315, which all belong to the same GOP. However, if sampling begins at T2, deleterious effects will occur during stream switching because the first key frames detected will be r3 321, b2 313, and g2 315. The key frame r2 311 is missed and the key frames will all belong to different GOPs.

Consequently, the techniques of the present invention contemplate starting the sampling in the middle of two GOPs. This improves the probably that key frames belonging to the same GOP will be detected. For each start time Tx, the algorithm calculates an offset, d, which should be added to Tx to get a suitable start position for the sampling. In the picture, T2+d=T3. That means that if we choose T2 as start time, T2 is adjusted with d to get T3 to get an improved start time.

If the key frames are perfectly periodic, occurring once every GOP interval, d would be constant for each value of T. This is often not the case, there is usually some small drift (e.g. due to rounding etc in the live encoder). This means d should be recalculated regularly to adjust to the drift in the live encoder. In particular embodiments, d is updated every 3rd minute.

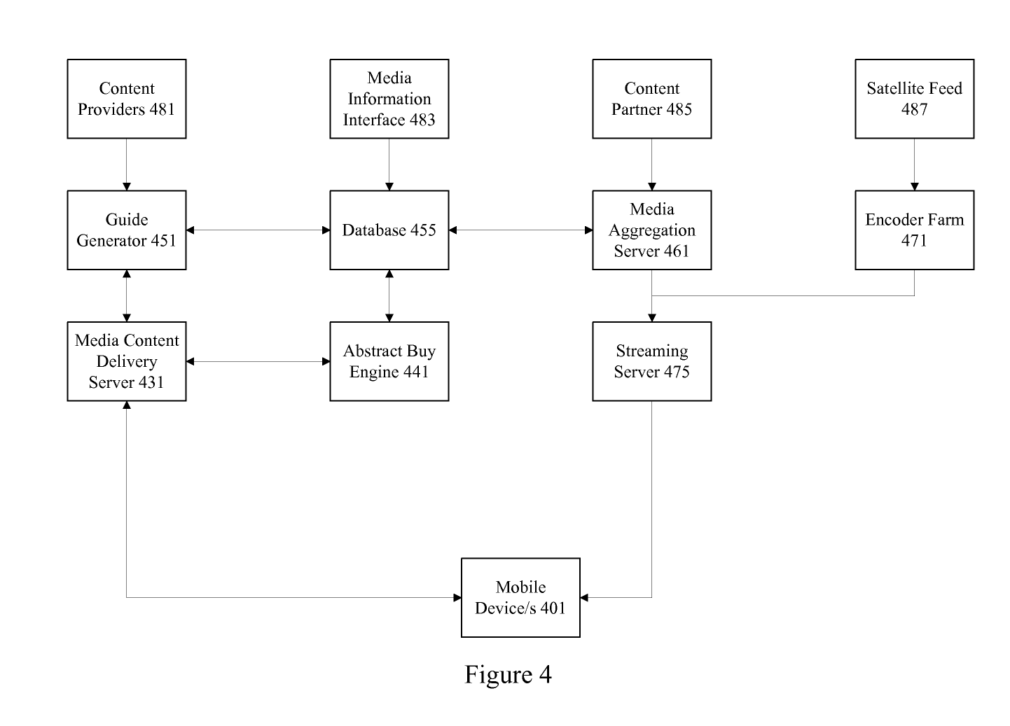

FIG. 4 is a diagrammatic representation showing one example of a network that can use the techniques of the present invention. Although one particular example showing particular devices is provided, it should be noted that the techniques of the present invention can be applied to a variety of streaming servers and networks. According to various embodiments, the techniques of the present invention can be used on any streaming server having a processor, memory, and the capability of identifying characteristics of frames such as frame type in media stream. According to various embodiments, a streaming server is provided with video streams from an associated encoder and handles connection requests from client devices such as computer systems, mobile phones, personal digital assistants, video receivers, and any other device having the capability of decoding a video stream.

According to various embodiments, media content is provided from a number of different sources 485. Media content may be provided from film libraries, cable companies, movie and television studios, commercial and business users, etc. and maintained at a media aggregation server 461. Any mechanism for obtaining media content from a large number of sources in order to provide the media content to mobile devices in live broadcast streams is referred to herein as a media content aggregation server. The media content aggregation server 461 may be clusters of servers located in different data centers. According to various embodiments, content provided to a media aggregation server 461 is provided in a variety of different encoding formats with numerous video and audio codecs. Media content may also be provided via satellite feed 457.

An encoder farm 471 is associated with the satellite feed 487 and can also be associated with media aggregation server 461. The encoder farm 471 can be used to process media content from satellite feed 487 as well as possibly from media aggregation server 461 into potentially numerous encoding formats. The media content may also be encoded to support a variety of data rates. The media content from media aggregation server 461 and encoder farm 471 is provided as live media to a streaming server 475. According to various embodiments, the encoder farm 471 converts video data into video streams such as MPEG video streams with key frames and predictive frames.

Possible client devices 401 include personal digital assistants (PDAs), cellular phones, personal computing devices, computer systems, television receivers, etc. According to particular embodiments, the client devices are connected to a cellular network run by a cellular service provider. Cell towers typically provide service in different areas. Alternatively, the client device can be connected to a wireless local area network (WLAN) or some other wireless network. Live media streams provided over RTSP are carried and/or encapsulated on any one of a variety of networks.

In particular embodiments, some client devices are also connected over a wireless network to a media content delivery server 431. The media content delivery server 431 is configured to allow a client device 401 to perform functions associated with accessing live media streams. For example, the media content delivery server allows a user to create an account, perform session identifier assignment, subscribe to various channels, log on, access program guide information, and obtain information about media content, etc. According to various embodiments, the media content delivery server does not deliver the actual media stream, but merely provides mechanisms for performing operations associated with accessing media.

In other implementations, it is possible that the media content delivery server also provides media clips, files, and streams. The media content delivery server is associated with a guide generator 451. The guide generator 451 obtains information from disparate sources including content providers 481 and media information sources 483. The guide generator 451 provides program guides to database 455 as well as to media content delivery server 431 to provide to mobile devices 401. The media content delivery server 431 is also associated with an abstract buy engine 441. The abstract buy engine 441 maintains subscription information associated with various client devices 401. For example, the abstract buy engine 441 tracks purchases of premium packages.

Although the various devices such as the guide generator 451, database 455, media aggregation server 461, etc. are shown as separate entities, it should be appreciated that various devices may be incorporated onto a single server. Alternatively, each device may be embodied in multiple servers or clusters of servers. According to various embodiments, the guide generator 451, database 455, media aggregation server 461, encoder farm 471, media content delivery server 431, abstract buy engine 441, and streaming server 475 are included in an entity referred to herein as a media content delivery system.

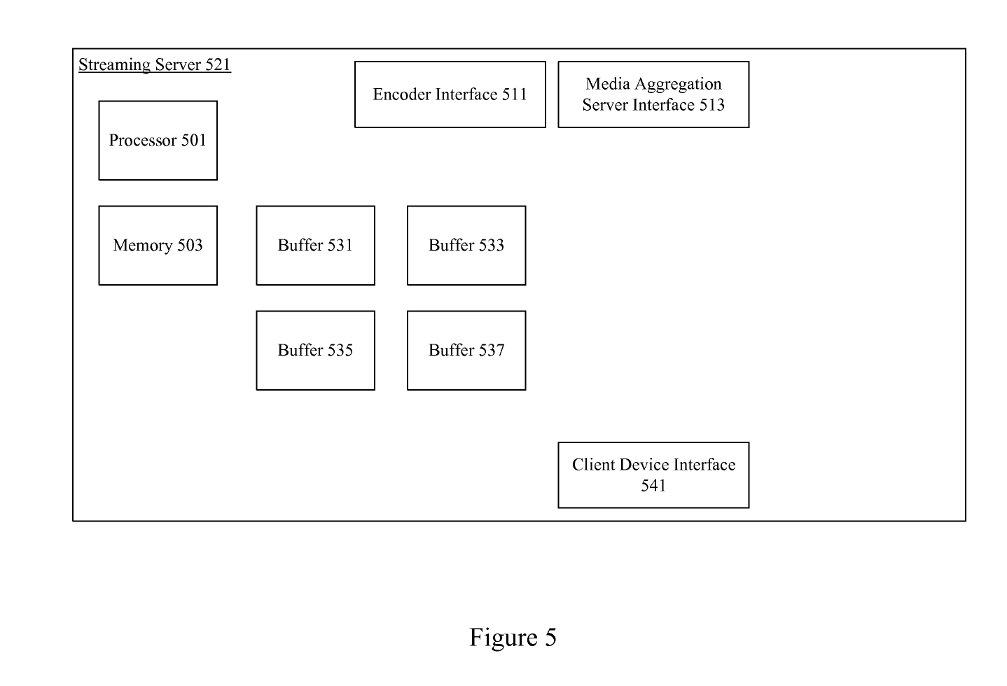

FIG. 5 is a diagrammatic representation showing one example of a streaming server 521. According to various embodiments, the streaming server 521 includes a processor 501, memory 503, buffers 531, 533, 535, and 537, and a number of interfaces. In some examples, the interfaces include an encoder interface 511, a media aggregation server interface 513, and a client device interface 541. The encoder interface 511 and the media aggregation server interface 513 are operable to receive media streams such as video streams. In some examples, hundreds of video streams associated with hundreds of channels are continuously being received and maintained in buffers 531, 533, 535, and 537 before being provided to client devices through client device interface 541.

According to various embodiments, the streaming server 521 handles numerous connection requests from various client devices. Connection requests can result from a variety of user actions such as a channel change, an application launch, a program purchase, etc. In some instances, a streaming server 521 simply provides the first available frame followed by subsequent frames in response to a client device connection request. However, the techniques of the present invention contemplate an intelligent streaming server that identifies key frames in video streams and provides a key frame initially to a client device. The key frame includes substantially all the information needed for a client device to begin display a correct video frame.

According to various embodiments, buffers 531, 533, 535, and 537 are provided on a per channel basis. In other examples, buffers are provided on a per GOP basis. Although buffers 531, 533, 535, and 537 are shown as discrete entities, it should be recognized that buffers 531, 533, 535, and 537 may be individual physical buffers, portions of buffers, or combinations of multiple physical buffers. In some examples, virtual buffers are used and portions of a memory space are assigned to particular channels based on need.

Although a particular streaming server 521 is described, it should be recognized that a variety of alternative configurations are possible. For example, some modules such as a media aggregation server interface may not be needed on every server. Alternatively, the multiple client device interfaces for different types of client devices may be included. A variety of configurations are possible.

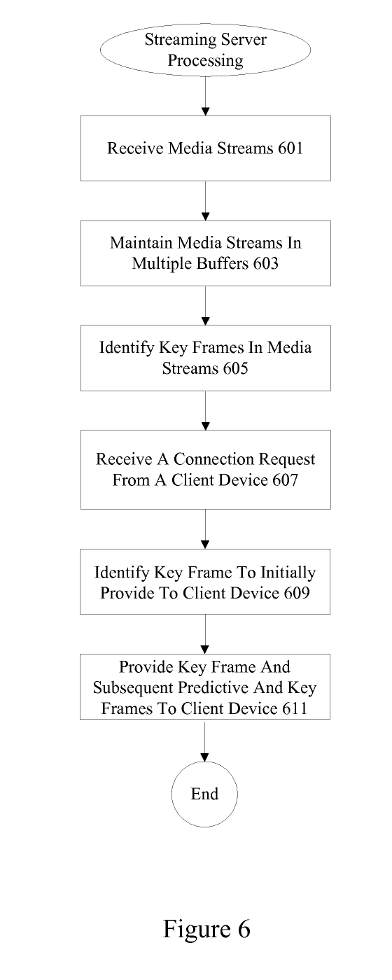

FIG. 6 is a flow process diagram showing one example of streaming server processing. At 601, media streams are received. According to various embodiments, media streams are continuously being received at a streaming server. At 603, media streams are maintained in multiple buffers. At 605, key frames in media streams are identified. In some examples, identifying key frames may involve determining the video codec, the GOP size, and/or the frame size and performing decoding or partial decoding of frames. A streaming server may be able to determine key frames by identifying the start of a GOP and the GOP size and flagging each start of a GOP as a key frame. A streaming server may also identify larger frames as key frames.

Partial decoding or full decoding can also be used. At 607, a connection request from a client device is received. At 609, a key frame to initially provide to the client device is identified. In some examples, the key frame identified is the earliest key frame for the requested channel available in a buffer for the channel. At 611, the key frame and subsequent predictive and key frames are sent to the client device 611.

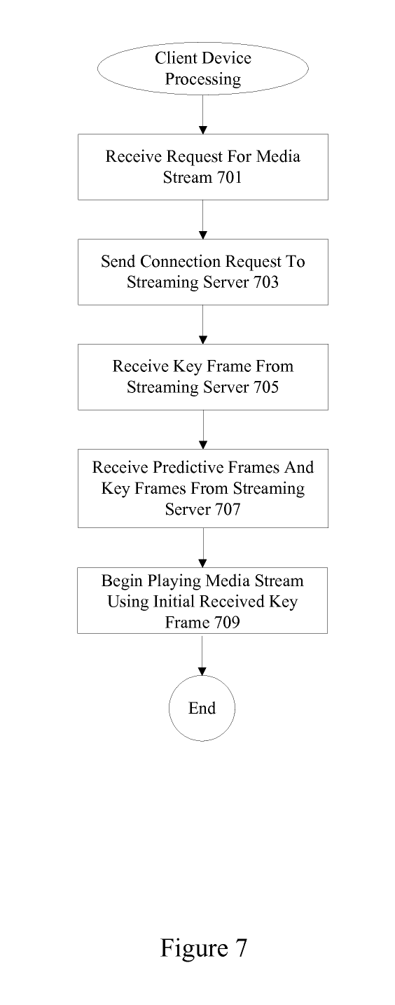

FIG. 7 is a flow process diagram showing one example of client device processing. In some examples, a client device is a mobile device. However, it should be noted that a client device can be any device associated with a decoder that is capable of displaying a video frame. That is a client device can be any computer system, portable computing device, gaming device, mobile phone, receiver, etc. At 701, a request is received for a media stream. According to various embodiments, the request on the client device may be the result of a user action. At 703, the client device sends a connection request to the streaming server. According to various embodiments, the connection request identifies a particular program or channel. At 705, a key frame is received from the streaming server. According to various embodiments, the client device receives the key frame first before any other frames. At 707, subsequent predictive frames and key frames are received from the streaming server. At 709, the client device plays the media stream using the initial received key frame. In some examples, the client device includes a decoder that processes the video stream received from the streaming server. In other examples, a decoding device may reside between the client device and the streaming server, and the client device simply plays video data.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A system, comprising:
an interface configured to receive a plurality of variant media streams corresponding to a plurality of quality levels for a piece of media content and a request from a device to switch from a first variant media stream to a second variant media stream at time Tx;
a processor configured to determine an offset d, wherein d is used to modify Tx to determine a start time for key frame sampling, wherein key frame sampling comprises identifying a plurality of key frames for the plurality of variant media streams.

2. The system of claim 1, wherein a plurality of offsets is calculated for each of a plurality of possible start times for a stream switch.

3. The system of claim 2, wherein the plurality of offsets are recalculated every few minutes.

4. The system of claim 3, wherein the plurality of offsets are recalculated based on the amount of drive in a live encoder.

5. The system of claim 1, wherein key frame sampling occurs at a point in time substantially in the middle between the starting points of two groups of pictures (GOPs).

6. The system of claim 1, wherein if T2 is identified as a stream switch time, T2 is adjusted with D to get T3 as an improved start time for key frame sampling.

7. The system of claim 1, wherein the request to switch from the first variant media stream to the second variant media stream is received at a streaming server.

8. The system of claim 1, wherein the plurality of variant media streams correspond to a plurality of resolutions for the same piece of media content.

9. The system of claim 1, wherein the second variant media stream is sent to a different device than the first variant media stream.

10. A method, comprising:
receiving a plurality of variant media streams corresponding to a plurality of quality levels for a piece of media content;
receiving a request from a device to switch from a first variant media stream to a second variant media stream at time Tx;
determining an offset d, wherein d is used to modify Tx to determine a start time for key frame sampling; and
identifying a plurality of key frames in the plurality of variant media streams.

11. The method of claim 10, wherein a plurality of offsets are calculated for each of a plurality of possible start times for a stream switch.

12. The method of claim 11, wherein the plurality of offsets are recalculated every few minutes.

13. The method of claim 12, wherein the plurality of offsets are recalculated based on the amount of drive in a live encoder.

14. The method of claim 10, wherein key frame sampling occurs at a point in time substantially in the middle between the starting points of two groups of pictures (GOPs).

15. The method of claim 10, wherein if T2 is identified as a stream switch time, T2 is adjusted with D to get T3 as an improved start time for key frame sampling.

16. The method of claim 10, wherein the request to switch from the first variant media stream to the second variant media stream is received at a streaming server.

17. The method of claim 10, wherein the plurality of variant media streams correspond to a plurality of resolutions for the same piece of media content.

18. The method of claim 10, wherein the second variant media stream is sent to a different device than the first variant media stream.

19. An apparatus, comprising:
means for receiving a plurality of variant media streams corresponding to a plurality of quality levels for a piece of media content;
means for receiving a request from a device to switch from a first variant media stream to a second variant media stream at time Tx;
means for determining an offset d, wherein d is used to modify Tx to determine a start time for key frame sampling; and
means for identifying a plurality of key frames in the plurality of variant media streams.

20. The apparatus of claim 19, wherein a plurality of offsets are calculated for each of a plurality of possible start times for a stream switch.
